(19) United States
(12) Patent Application Publication
(10) Pub. No.: US 2008/0059304 A1
(43) Pub. Date: Mar. 6, 2008

(54) METHOD OF ACTIVE ADVERTISING AND PROMOTION IN AN ONLINE ENVIRONMENT

(76) Inventor: Robert Scott Kimsey, Boonville, MO (US)

Correspondence Address: Robert Kimsey, 804 Shamrock Avenue, Boonville, MO, 65233, US

(21) Appl. No.: 11/837,510

(22) Filed: Aug. 11, 2007

Related U.S. Application Data
(60) Provisional application No. 60/822,627, filed on Aug. 16, 2006.

(51) Int. Cl. G06Q 30/00; A63F 13/12

(52) U.S. Cl. 705/14; 463/42

(57) ABSTRACT

The present invention provides a method of active advertising and promotion within an online environment, the method including the steps of providing an online gaming environment and providing a quest within that environment, the quest being sponsored by an advertiser or other third party. In another aspect of the present invention, the method includes the step of rewarding the player within the online gaming environment for successful completion of the quest.

### CROSS-REFERENCE TO RELATED APPLICATIONS

This Application claims priority to U.S. Provisional Patent Application No. 60/822,627, filed Aug. 16, 2006, which is incorporated herein by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The growth in recent years of online environments, including gaming and social environments, has been phenomenal. Millions of people around the world interact daily in these online environments, communicating, competing, or otherwise interacting with one another. A major development in online communities has been the rise of massively-multiplayer online games (MMOs), including massively-multiplayer online roleplaying games (MMORPGs).

In a typical MMORPG, vast numbers of players interact with one another in a virtual world. Players generally take on the persona of a ‘character,’ typically in a fantasy or science fiction setting, and progress through the world of the game in a number of ways, including killing or otherwise defeating enemies, completion of quests, development of skills and professions that benefit the character, and numerous other ways of advancement. One such MMORPG, Blizzard Entertainment's World of Warcraft®, is one of the most played games in North America and, as of this writing, boasts between five and six million subscribers worldwide.

Given the growing popularity of MMOs of all kinds, and the growing number of individuals worldwide who participate in such games, the attention of advertisers has understandably been drawn to this media. Advertising in video games is a swiftly growing area of industry, and the principles applied to advertising in video games generally may also be applied to advertising in MMOs.

One enumerated principle of video game advertising is that the advertisements must not take the player out of the game. That is, the advertisements should be of such a nature as to be visible and effective, but remain essentially in the background and should not remove the player from the immersive gaming experience. In essence, the current teaching is that the advertisement should be passive, and indeed such advertisements have taken the form of product placement on, for example, billboards in the background of the virtual or online gaming world.

The present invention is directed to a method of active advertising or promotion in online or virtual environments such as MMOs, being directed in large part to involve the player directly in the promotion. Thus, the principles of the present invention set forth herein go against the current teachings in the art. The present method is based on a recognition of the fact that, contrary to the teaching in the art, active advertising in online environments such as MMOs can provide even greater benefit and goodwill to an advertiser, while at the same time enhancing the experience of the player of participant in the virtual world.

### BRIEF SUMMARY OF THE INVENTION

The present invention provides a method of active advertising and promotion within an online environment, the method including the steps of providing an online gaming environment and providing a quest within that environment, the quest being sponsored by an advertiser or other third party.

In another aspect of the present invention, the method includes the step of rewarding the player within the online gaming environment for successful completion of the quest.

In another aspect of the present invention, the reward provided to the player is an in-game item usable by the player.

In another aspect of the present invention, the in-game reward provided to the player includes a trademark or logo of the sponsor such that it is visible to other players within the online environment.

In another aspect of the present invention, the player is rewarded in the real-world for successful completion of the quest within the online environment.

In another aspect of the present invention, the quest includes both real-world and in-game portions.

In still another aspect of the present invention, the real-world portion of the quest includes the purchase of a product of the sponsor.

In another aspect of the present invention, the real-world portion of the quest includes visiting a web site of the sponsor.

In another aspect of the present invention, the quest includes in-game verification of a real-world purchase by the player.

In another aspect of the present invention, the sponsor generates at least some content for the quest.

### DETAILED DESCRIPTION OF THE INVENTION

For purposes of the present document, the terms online environment, virtual environment, virtual world, and online world, are used interchangeably and refer to any virtual environment, whether contained within the internet, a private network, or in any other manner of creating virtual environments, either now known or developed in the future, including partially or fully immersive virtual reality environments.

The terms MMO and MMORPG are use interchangeably to refer to any massively-multiplayer online game or game set in a virtual world or environment as defined above.

The terms advertising, advertisement, and promotion are used interchangeably herein.

The term “quest” is used herein to indicate any activity undertaken to satisfy an in-game requirement, attain an in-game goal, or accomplish any other end within the virtual gaming world. As used, the term includes any real world activities that must be, or may be, undertaken to further in-game goals or desires. Further, a ‘quest’ could be something as simple as setting up an in-game storefront allowing players to purchase items (either in-game items or real-world items) therefrom. The term ‘quest’ is used to refer to any of these in-game or real-world options or requirements provided for players, and is used for the simplicity and clarity of employing a single term to encompass these many activities. The term is to be understood broadly as defined.

A goal of the present advertising and promotion method is to engage the participant or player in the online environment (hereinafter referred to as the player) in such as way that the player is drawn actively into the promotion as part of the game. Various exemplary embodiments of the present method are described below, though it is contemplated that various other embodiments will be apparent to those of skill in the art upon reading this disclosure. The common theme in each of the examples, however, is that the player interacts with or is engaged directly with the advertisement or promotion, either in-game, in the real world, or both. The advertisement or promotion becomes part of the gaming environment itself and, as such, the sponsor or advertiser becomes a direct participant in the gaming world and in the immersive gaming experience of the players.

I. Sponsorship of Quest and Reward

As noted above, a common way of progressing through an MMO, particularly a typical fantasy MMO, is by completion of quests. As a player, using his character, adventures through a virtual world acquiring and completing quests, the character is typically rewarded with experience points, skill points, money, magical and other items, combinations of these, or other rewards. One embodiment of the present invention couples this system of questing with the active advertising and promotion method of the present invention. In such an embodiment of the present method, an entity wishing to advertise or promote itself in an online or virtual environment, such as in an MMO, would undertake to sponsor a quest as well as, preferably, the reward received by the player at the end. The owner of the MMO or other online environment may set rates for sponsorship of various quests in-game. The actual sponsorship may be accomplished in a number of ways, some of which are now described. It should be noted, however, that various modifications to precisely how the sponsorship is accomplished will be readily apparent to those of skill in the art upon reading this disclosure.

Once an entity has agreed to sponsor a quest, the owner of the virtual environment undertakes to properly incorporate the sponsorship into the online environment. Precisely how the sponsorship is incorporated may vary from sponsorship to sponsorship depending on the specific requirements of the quest, sponsorship, and/or online environment. At the most basic level, for example, when a character receives a quest the character is informed, such as by text or a graphic onscreen, about the sponsorship. It is preferred, however, that the advertising methods of the present invention are more active and engage the players more thoroughly, as described below for example.

### EXAMPLE 1

### Sponsored Quest for a Unique Item

Now presented is one embodiment of the present method directed to sponsorship of a quest and reward. This example is directed to a quest having a specific starting time, and resulting in a unique or small number of sponsored rewards. It is contemplated, however, that such a quest could be provided on a continuous basis, for players to acquire and complete in their own time, each receiving the sponsored reward.

In this exemplary embodiment of the present invention, it is contemplated that a shoe manufacturer wishes to sponsor a quest in the online environment, and sponsor a reward for completion of the quest that reflects the business of the sponsor. Once the sponsor agrees to sponsor the quest, the owner of the online environment preferably places notices or otherwise advertises the quest within the online environment. These notices or advertisements may indicate, for example, that all players desiring to take part in the quest should meet at a certain location and at a certain time, and should be provided in such a manner and with sufficient notice to develop interest in the quest.

The specifics of the quest may be developed by either the sponsor, the owner of the online environment, a third-party marketing and advertising company, or any combination thereof. In this example, the quest involves, specifically, finding and defeating a boss (generally an exceptionally strong adversary encountered near or at the end of a given quest) who is in possession of a pair of boots or shoes of speed that serve to increase the movement rate of the wearer (in some MMOs this is no small reward, as much of the game time is spent walking or running from one location to the next over great distances in the virtual world). Players wishing to undertake the quest meet in the appointed place at the appointed time and receive details of what must be done in order to complete the quest. Once the quest begins, the players compete with one another to reach the boss and defeat him, thereby retrieving the boots or shoes of speed that also serve as the quest reward. The first player to complete the quest wins the reward and is able to equip his character with the boots or shoes of speed. In the foregoing example, the competition between players may be such that the players all interact with one another, in essence competing directly to be the first to unseat the boss and obtain the reward. Alternatively, small groups or players, or even individual players, may enter ‘instances’ of the quest, thereby being isolated from the whole of the players attempting the quest, with the winner being the first group or individual, as determine, for example, by a computer clock on a game server, to unseat the boss and claim the reward.

It is preferred that the in-game graphic used for the reward item (the boots or shoes of speed) include the name, trademark, or logo of the sponsor visibly thereon. Thus, when the winning player equips the boots or shoes of speed and continues to interact in the game world, other players from that point forward will be exposed to the logo, name, or trademark of the sponsor when they see the winning character walking around in, or otherwise interacting with, the virtual world. If the reward provides the winning character with sufficient attributes or in-game advantages, the reward item may even become a source of envy, with many players wishing to acquire boots or shoes having the logo, name, or trademark of the sponsor shoe manufacturer contained thereon. In an MMO set in a contemporary or science fiction setting, providing a reward that displays a sponsor's logo or trademark thereon is relatively easy to do without disrupting the feel of the game. After all, these sponsors exist contemporaneously, and it is not unreasonable to assume that they may well exist in the future (i.e. in a science fiction setting). Even in a fantasy setting, however, providing such a reward can be desirable. Many popular fantasy movies, books, and games incorporate, often in a tongue-in-cheek fashion, modern references, or incorporate modern sensibilities, particularly in terms of product placement. The gaming audience is sophisticated enough to appreciate this sort of product placement in the appropriate setting.

The above example accomplishes a number of goals. There is no doubt that the sponsorship gets the name of the sponsor or advertiser in front of various players who participate in (or simply hear about) the quest. The sponsorship even ensures long term exposure of the sponsor's name, logo, or trademark to those in the game because players will see the graphic of the sponsors name, logo, or trademark on the reward item and the reward will be valued by the players in the game. Perhaps even more importantly, the sponsorship establishes a great deal of goodwill between the players (even those who do not win the reward) and the sponsor. Players of the MMOs tend to think of themselves as a community (and indeed the establishment of a community is a desire of the owner or provider of the online environment). The fact that a sponsor has taken enough notice of and interest in an online environment to sponsor a quest as described above will tend to generate goodwill toward that sponsor. Players will identify with and appreciate the efforts of the sponsor. Also, as is commonly seen within gaming communities, such a sponsorship is likely to engender a deal of product loyalty on the part of players.

Although the quest described in the example above involves defeating a boss and acquiring an item, any suitable quest may be used in connection with a sponsorship of the sort described above. For example, the quest may involve journeying to distant locations, killing or otherwise defeating enemies, solving puzzles, retrieving various items, speaking with in-game characters (or non-player characters), or any combination of these or other suitable quests. In addition, although as described above the quest commences at a certain time and results in one winner, it is contemplated that the quest may be repeated at various intervals, resulting in multiple winners over time, or that the quest may involve participants moving into an ‘instance’ when confronting the boss (or other goal of the quest) such that there may multiple winners at any given time. Alternatively, the quest may be continuously available for players to acquire and complete within their own timeframes, leading to the reward item being commonplace (and therefore often seen) within the virtual environment.

II. Sponsorship Involving In-Game and Real-World Activities

In another embodiment of the present method, the sponsorship or advertisement undertaken by the entity involves not only actions within the virtual environment, but also in the real world, where the real world actions impact what occurs in-game in terms of character rewards, quest completion, and the like. This aspect of the present invention may be implemented in a variety of ways, however two specific embodiments are described below.

### EXAMPLE 2

### Product Purchase and In-Game Confirmation

This exemplary embodiment of the present invention is a twist on a standard feature of MMO quests, which is for a player to gather a certain number of a specific item and return them to a non-player character (NPC) or certain location within the virtual world to receive a reward.

For purposes of this example, it is contemplated that a soft-drink manufacturer wishes to sponsor a quest that extends into both in-game and real world activities and is tied to the purchase of its products. The owner of the virtual world inserts the quest into the virtual environment, and players within the virtual environment may then complete the quest and receive an in-game reward for so doing. In the present example, the NPC informs the player that a code is needed to open a vault containing, among other things, a reward, and that the code exists only in fragments scattered throughout the virtual world. Alternatively the fragments might be of a key. The player must then set out to locate these fragments. When the player finds the location of a fragment, he is asked to enter a code printed on the underside of a lid or cap of one of the sponsor's soft drinks, which is obtained by the player by purchasing the soft drink in the real world. When the player enters this code correctly, he receives the appropriate fragment containing the code to open the vault, or the appropriate fragment of the key, or any other pertinent object depending on the design of the quest. Once all fragments have been obtained (i.e. once the appropriate number of products have been purchased, each containing codes beneath the lids, and the player has found the appropriate in-game location for each key), the player returns to the beginning of the quest (or other designated location) and receives the reward.

In the above example, it is preferred that each code contained beneath the cap of the soft drink of the sponsor is unique, and that each code may only be used viably once in the game. This prevents sharing of codes among friends and online. This example of the present method exposes the player to the sponsor's product, for which the player will develop positive sentiments, and interjects a real world component into completion of the online quest. It is contemplated that the teachings of the present invention may be used in various other ways to provide a link between an in-game sponsorship or advertisement and real world activities (such as product purchase).

### EXAMPLE 3

### Sponsor Web Interaction Coupled with In-Game Actions

This example of the present method is similar to that set forth in example 2, except that it is not necessary for the player to actually purchase any of the sponsors items to complete the quest. Rather, at each in-game location wherein the player may receive a code or key fragment, the player is presented with a question that must be answered. The answer is preferably something that the player is not likely to know offhand, but rather something that can be obtained online at the sponsor's website. The player is then able to go to the sponsor's web site, find the information (such as in the online equivalent of a scavenger hunt), and enter the information at the appropriate time in-game. If the information is correct, the player receives the fragment of code or key and, after answering all questions and receiving all fragments, is able to complete the quest.

This example serves to direct the player to the sponsor's web site where the player will be paying greater attention that many internet surfers because the player is looking for a specific piece of information. The player is likely to read much of the content of the website, and to look at length at many of the graphics and other content. In the course of searching for the information needed to complete the online quest, the player is exposed in a positive manner to the goods and/or services of the sponsor.

In both of the foregoing examples, the player is involved in in-game activities as well as real-world activities that expose the player to the sponsors goods and/or services.

III. Sponsor Quest with Real World Reward

In addition to sponsoring a quest or other activity that results in an in-game reward, as described above, an advertiser may also sponsor an in-game activity (i.e. a quest) and provide a real world reward for successful completion of the activity. Such rewards may entice a good number of participants and generate a great deal of discussion both in-game and in the real world. In addition, real world prizes offer the same advantages offered by traditional promotions wherein prizes are given to participants. Advertisers have long recognized that such promotions can be quite successful, and often engender more word-of-mouth advertising than do commercials or passive advertisements. Further, such promotions tend to increase the likelihood that participants and others will remember the sponsor or advertiser and its products.

### EXAMPLE 4

### Quest for Real World Reward

An example of a sponsorship of a quest for a real world reward is now provided. It is contemplated that the following is exemplary only, and that upon reading this disclosure many variations on the following example will be readily apparent to those of skill in the art.

For purposes of the present example, it is supposed that a manufacturer of MP3 audio players wishes to give away fifty such players to participants in a promotion that the manufacturer is sponsoring within an MMO. The promotion may be advertised both in-game and in the real world (via, for example, television, radio, the internet, and the like). Participants are provided with the details of the quest, including when and where to pick up the quest in-game. The particular quest may be tied to the advertiser's business or may be wholly unrelated thereto. In a science fiction environment, for example, the quest may involve traveling a great distance in-game and overcoming obstacles to reach an NPC and deliver to that NPC a digital sound recording. In a fantasy setting the same general quest may be put in place, but the delivery may be of a music box instead. Alternatively, the actual quest itself may be unrelated to the subject of sound recordings or music. Once the quest begins, the participants compete with one another in order to be the first to reach the named NPC and deliver the appropriate item. In the present example, wherein the advertiser wishes to reward fifty participants with one of its MP3 audio players, the first fifty participants to successfully complete the quest receive the rewards. The information provided above with respect to direct competition versus instances applies here as well.

The advantages provided by a promotion such as that set forth in this example are numerous. The existence of the quest and reward in and of itself will spur talk about the advertiser's product, both in-game and in the real world. Once those first fifty who successfully complete the quest receive their rewards (in this case, MP3 audio players), there will be more in-game and real world discussion of the product, creating a likelihood that others will wish to obtain the product for themselves by purchasing it. Once again goodwill is created between the MMO player base and the sponsor or advertiser, due not only to the ‘advertising’ value of the sponsorship but also due to the participation by the sponsor within the gaming world, which will be valued by players of the game. To further cement the relationship between the players in-game and the sponsor, the MP3 players may be shipped with music or other audio from the game preloaded therein. If appropriate, an in-game graphic may also be provided. For example, a player's character may be seen in-game as having an MP3 player that looks substantially similar to that made by the sponsor, and/or includes the sponsor's logo thereon.

IV. Direct PvP Sponsorship

In the examples above, although players may be competing against one another for the rewards offered by the sponsor, the character of the quests or activities themselves are known in the gaming world as “player versus environment” (PvE). That is, the obstacles the players must overcome are controlled by the game software itself, whether it be traveling across distances and varied terrain, defeating monsters, solving puzzles, or defeating NPCs. A major attraction of MMOs, however, is the ability to engage in direct “player versus player” (PvP) activity, such as combat. During a PvP activity, one or more players are pitted directly against one another, with each player's skills and the relative attributes of their characters determining the outcome. It is contemplated that in another embodiment of the present invention an advertiser may sponsor direct PvP activities, such as a PvP combat tournament, providing rewards either in-game or in the real world to participants in the activity.

### EXAMPLE 5

### Sponsorship of a PvP Arena

For purposes of this example, an advertiser wishes to sponsor an in-game PvP activity and provide a reward to the top three participants therein. In the present example, the activity takes place in the form of a PvP arena, wherein participants sign up in-game to fight one another in a tournament-style fashion, and as various rounds of the tournament proceed the winners in each round advance to the next while the losers are removed from the tournament (or, alternatively, to a loser's bracket where additional rewards may be provided). Such a tournament might take place over a number of days, with the names of scheduled participants posted in-game or on the internet, along with the time at which the participants will meet one another in combat. Various other players may be provided with the option to watch the contest in-game, and the sponsor (or the provider of the MMO) may also post results on the internet and update them as developments in the tournament ensue. As the tournament proceeds, with various participants moving along brackets or being removed therefrom, the tournament eventually reaches a final two participants who then engage in direct PvP combat for the championship. First, second, and third place prizes (for example) are rewarded at the close of the tournament. These rewards may be made automatically, such as by updating the account of the player in question or by automated shipment of the real world reward item to the player, or an in-game ceremony may be held wherein the winning participants are honored and receive their rewards.

Once again the above provides a great deal of word-of-mouth advertising for the sponsor, as well as generating excitement among the MMO's player base (at least some of which will likely translate into goodwill for the sponsor). Further, as with the other embodiments of the present method, a sponsorship of this sort brings the sponsor within the game world itself, making the sponsor and its activities part of the ongoing events of the world. A sponsor that regularly engages in such activities may become a positive fixture of the game itself.

V. Participation in Virtual Economy

MMOs tend to develop a virtual economy within the environment of the game, with aspects of this economy making their way into the economy of the real world through the selling of items of worth in-game in the real world such as through auction sites or other web sites. A sponsor or advertiser, using the present principles of active engagement with the players in-game, could take advantage of the in-game economy in order to advertise or promote products. In simplest form, this embodiment of the present invention may include an in-game storefront through which players, via their characters, can purchase the sponsor's goods. For example, a clothing manufacturer may sponsor an in-game clothing store where various items of clothing are available for purchase by players within the game. These items could be purchased simply to change the appearance of a character in-game, or may be provided with enhancements that aid a character wearing a particular item in playing the game. The storefront may be constructed to look like a real shop in, for example, a city located in the virtual gaming world, and may make use of the sponsor's name and logo or trademark. As the sponsor's in-game products become desired by players, an economy may form around these products, particularly if some of the products are rare and/or expensive. Further, players of the game will feel goodwill or associate with the in-game sponsor's products, and that goodwill may carry over to the player's real-world purchases of the sponsor's products. Sponsors may even wish to supply real-world counterparts of their virtual products, for sale online or in a store, so that players can own, in the real-world, items that their characters own in-game. In addition to a virtual storefront, a sponsor may sell products via the web, accessible outside of the game, such that players receive the item in-game for use with their character. Likewise, sponsors may tie their in-game items to real world purchases so that, for example, a player who purchases shoes from a sponsor shoe manufacturer in the real world also receives, in-game, an item from the sponsor that can be worn by the player's character. By placing items into the stream of commerce within the virtual gaming world itself, a sponsor can generate goodwill and interest in its real world products.

VI. Sponsor In-Game Champions

In addition to situations in which a sponsor takes a relatively passive role in the actual course of competition among players embarking on a given quest, the sponsor may, through its own employees, agents, or other designees, take a more active role in the course and outcome of the quest. This active role may take the form of in-game personas or characters controlled by employees, agents, or designees of the sponsor, acting in effect as ‘champions’ on behalf of the sponsor (though they may or may not be characterized as such within the game). The ‘sponsor champions’ may provide useful information or items to players within the game as the players move through a quest, and may challenge them, such as with riddles or combat, prior to providing this desired information. Players that fortuitously encounter these sponsor champions during the course of a quest may benefit from the encounter, or may be hindered by it (as in the case of a defeat in combat), depending on their response to the encounter. Likewise, employees, agents, or other designees of the sponsor may take control of in-game monsters or NPCs that are included as part of the quest, such that when players encounter these monsters or NPCs they are matching their skill with another human being rather than with computer artificial-intelligence that controls many of the other in-game monsters of NPCs. Providing human-interaction between players and employees, agents, or other designees of the sponsor further increases the interactivity of the game and also creates a positive sense of association with the sponsor as the player is engaged in enjoyable gaming with the employees, agents, or other designees of the sponsor. It is also contemplated that players who show exceptional skill in encounters with sponsor champions may themselves be recruited to serve as sponsor champions for future quests, or that the player who ‘wins’ a quest may serve as the in-game champion of a particular sponsor until either a specified time period has past or until that player is defeated by another player, who then takes on the mantle of the sponsor champion.

VlI. Miscellaneous

As has been noted above, upon reading this disclosure, numerous variations to what is described herein, numerous various embodiments of the present invention will be readily apparent to those of skill in the art. It is not feasible to attempt an exhaustive review of the various embodiments of the present invention in this document. So long as the underlying principle of active participation by a sponsor within an online or virtual world (such as an MMO) is preserved, the embodiments of the present method that may be developed are limited only by the imaginations of the MMO provider, the sponsor, or a third-party advertising firm. Set forth briefly below, however, are a number of additional embodiments of the present method.

While the examples provided above are directed to rewarding a participant or multiple participants, as described above they are directed to a single-player style of play, wherein each participant is acting on his own to achieve the goal. It is contemplated, however, that any of the above embodiments (or, indeed, any embodiments of the present method) may be directed toward group activities wherein multiple participants group together in-game to achieve the goal, and the reward is then divided among the group in any suitable fashion. In fact, some activities or quests that are sponsored may be such that it is impossible for a participant to be successful alone, requiring group cooperation to successfully complete the activity and win the reward. This takes full advantage of the multiplayer aspect of the virtual or online environment.

It is further contemplated that the sponsors active participation in the game world may take the form of a virtual spokesperson in-game. This spokesperson may take any form, but preferably changes from time to time as various sponsored activities or quests are completed by different in-game participants. For example, an advertiser may sponsor a quest to defeat a powerful monster in a fantasy MMO. The participant who first successfully completes the quest may then receive an in-game reward in the form of, for example, a cloak that provides the participant's character with desirable attributes in-game. While wearing this cloak, that participant may become the in-game spokesperson (or representative, in a broad sense, even if the player is required to do nothing to actively promote the sponsor) for the sponsor for the course of a month, being visible to the other players within the game and having the logo or trademark of the sponsor included on his cloak such that in-game players are able to see it. The in-game spokesperson may be provided with a number of in-game items to disseminate to others in the game over the course of the month, and may even be called upon to preside over the next occurrence of the quest when the month is complete. The winner of the next occurrence of the quest then receives the cloak and becomes the in-game spokesperson for the following month.

It is also contemplated that a sponsor may wish to contribute or maintain in-game content. New content is always avidly sought-after by participants in an online or virtual world, and in some cases providers of MMOs lose players because content cannot be provided as fast as players are able to move through it. In this embodiment of the present method, a sponsor may undertake to provide new content by, for example, funding the development of the new content by the MMO provider when the sponsor pays the advertising rate for this sort of sponsorship. The content provided may be anything, including, in a fantasy MMO, an intricate dungeon through which participants may venture to receive in-game and real world rewards, or, in a science fiction setting, a derelict spacecraft, an abandoned moon, or even a small planet, all with content desired by the players of the game and provided by the actions of the sponsor. Such sponsorships would generate goodwill toward the sponsor, and over time players may come to associated some sponsors with outstanding content, increasing the number of participants in that sponsor's content (and thereby increasing the advertising value of the content). Sponsors may even compete with one another to draw participants to their own content and away from the content of their competitors. Again, the sponsor becomes an active and visible part of the virtual world, rather than a passive and unobtrusive part of it.

The examples provided above are exemplary of the teachings of the present invention and are not limiting. Various modifications to the above examples, as well as additional implementations of the present teachings, will be readily apparent to those of skill in the art upon reading this disclosure. Even though the above description is directed primarily to MMOs, it is contemplated that the principles may be applied to smaller online environments that don't reach the level of participation necessary to be considered MMOs, or even to single-player games having no online component at all.

What is claimed is:

1. A method of active advertising and promotion within an online environment, the method comprising the steps of:
a. providing an online gaming environment;
b. providing a quest within said online gaming environment, said quest being sponsored by an advertiser.

2. The method according to claim 1, further comprising the step of:
c. rewarding a player within said online gaming environment for completion of said quest.

3. The method according to claim 2 wherein said player is rewarded by being provided in-game with an item usable by said player.

4. The method according to claim 3 wherein said item usable by said player includes a trademark of said advertiser, the trademark being visible to players in said online gaming environment.

5. The method according to claim 2 wherein said player is rewarded by being provided, in the real world, with a product of said advertiser.

6. The method according to claim 1 wherein said quest comprises:
a. an in-game portion; and
b. a real world portion.

7. The method according to claim 6 wherein said real world portion comprises purchasing at least one product of said advertiser.

8. The method according to claim 6 wherein said real world portion comprises visiting a web site of said advertiser.

9. The method according to claim 7 wherein said in-game portion comprises verification of said real world purchase of at least one product of said advertiser.

10. The method according to claim 1 wherein at least a portion of said quest includes content generated by the advertiser.

11. The method according to claim 2 wherein said reward includes designating said player as an in-game representative of said advertiser.

12. The method according to claim 11 wherein said in-game representative is selected from the group consisting of a spokesperson, champion, salesperson, model, or musician of said advertiser.

13. The method according to claim 1 wherein said quest includes recovery of a unique in-game item.

14. The method according to claim 1 wherein said quest includes a player-versus-player tournament.

15. The method according to claim 14 wherein said player-versus-player tournament is a combat-related tournament.

16. The method according to claim 1 wherein the quest includes an in-game storefront provided for players to purchase items selected from the group consisting of in-game items and real-world items.

17. A method of active advertising and promotion within an online environment, the method comprising the steps of:
a. providing an massively-multiplayer online roleplaying game environment; and
b. providing an interactive advertisement within said online gaming environment, said interactive advertisement being sponsored by an advertiser.

18. The method according to claim 17 wherein said interactive advertisement is an in-game item having an indicator of said advertiser included thereon.

19. The method according to claim 17 wherein said interactive advertisement is an in-game item provided to a player when said player makes a real-world purchase from said advertiser.

20. The method according to claim 17 wherein said indicator is selected from a group consisting of a trademark, logo, slogan, color, sound, or combination thereof of said advertiser.
